(19) United States
(12) Patent Application Publication
(10) Pub. No.: US 2017/0297966 A1
(43) Pub. Date: Oct. 19, 2017

(54) PLANT IRON SUPPLEMENT SYSTEM, AND METHOD OF PREPARATION THEREOF

(71) Applicant: Michael Krysiak, Green Bay, WI (US)

(72) Inventor: Michael Krysiak, Green Bay, WI (US)

(21) Appl. No.: 15/284,583

(22) Filed: Oct. 4, 2016

Related U.S. Application Data
(60) Provisional application No. 62/285,221, filed on Oct. 22, 2015.

(51) Int. Cl. C05D 9/02; C05G 3/00; C05D 3/02; C05G 3/04; C05D 3/00

(52) U.S. Cl. CPC C05D 9/02; C05G 3/04; C05D 3/00; C05D 3/02; C05G 3/0058

(57) ABSTRACT

A Plant Iron Supplement System and method of implementing same, serving as a soil conditioner for the benefit of treating Iron Deficiencies in plants, containing Magnetite (Fe₃O₄) and a Beneficial Carrier material.

### FIELD OF THE INVENTION

The present invention relates to a plant iron supplement soil conditioner system for the purpose of improving iron deficiency in plants for horticultural, turf and agricultural use containing at least Magnetite (Fe₃O₄) and a Beneficial Carrier material, and a method of preparation of the composition.

### BACKGROUND OF THE INVENTION

A healthy soil environment consists of biologic, physical and chemical components interacting in dynamic ways that provide plants with a stable growing environment. The soil environment in lawns and gardens often lacks the correct plant nutrients at the precise balance to stimulate optimum growth. In these circumstances, it is necessary to add amendments to support healthy plant growth and development.

Iron is the 4th most abundant element in earth's crust and the 3rd most limiting nutrient to plant growth. Plants need iron as a micronutrient to support essential functions. Iron is important in forming chlorophyll, nitrogen fixation, and growth and development. An iron deficiency causes chlorosis or yellowing leaves, poor growth and leaf loss.

Iron treatment of soil for the benefit of plant life is widely practiced and known in the art. Iron deficiency is a limiting factor of plant growth. Rarely is an iron deficiency in plants caused by a lack of iron in the soil. Iron is typically abundant in the soil, but a variety of soil conditions can limit how well a plant can get to the iron in the soil.

The causes of iron deficiencies are complex and not clearly understood in many cases. Many reactions govern iron availability and contribute to the complexity of iron chemistry in soil. Deficiencies develop because soil chemical reactions render this iron unavailable to plants. Iron deficiency in plants can be caused by numerous reasons, some of which include: soil pH is too high (pH greater than 7.0); soil has too much clay; compacted or overly wet soils; too much phosphorus in the soil.

Several methods are available for treating iron deficiency. These include, but are not limited to: 1) soil application of elemental sulfur combined with ferrous (iron) sulfate; 2) soil application of iron chelates; 3) foliar sprays containing ferrous sulfate or chelated iron; or 4) trunk injection of ferric ammonium citrate or iron sulfate (trees only). Each of these treatments are known to have various limitations and capabilities in the treatment of iron deficiencies in various plant life.

Iron (Fe) in soil is a micronutrient and essential plant nutrient. Fe provides structural elements of porphyrin molecules (i.e., cytochromes, hemes, hematin, ferrichrome, and leghemoglobin) which are required for plant respiration and photosynthesis. Fe supplies the necessary electrochemical potential for many plant enzymes including synthesis of chlorophyll. Chlorophyll production is reduced with Fe deficiency and results in Fe stress chlorosis.

Iron Fe deficiency symptoms are visually first identifiable as interveinal reticulate chlorosis in the youngest leaves. Under severe Fe deficiency the further growth of new leaves and existing roots and leaves may be severely restricted or stop completely (Kosegarten et al., 1998; Bertoni et al., 1992).

Fe deficiency chlorosis is common on calcareous and high pH soils. Fe chlorosis is also observed during rainy, cool weather with high soil moisture and poor soil aeration. During these conditions root development and absorption of nutrients are reduced which further contributes to Fe stress. Soils low in organic matter (OM) induces Fe deficiency symptoms. Plants receiving primarily nitrogen (N) in the form of nitrate (NO₃−) have a higher probability to develop Fe chlorosis than when receiving ammonium (NH₄+). This is due to Fe solubility and plant Fe availability increased by the lower pH realized when NH₄+ is present (Epstein and Bloom, 2005).

Compared with the total amount of iron in soils, the amount of soluble iron available to plants is quite low. Fe oxide/hydroxide solubility decreases in the order of Fe(OH)3 amorphous >Fe(OH)3 in soil >γ-Fe₂O₃ maghemite >γ-FeOOH lepidocrocite >α-Fe₂O₃ haematite >α-FeOOH goethite (Chen and Barak, 1982). Inorganic soluble Fe forms encompass Fe3+, Fe(OH)2+, Fe(OH) and Fe2+ with solubility ordered by hydrous FeIII oxides (Lindsay, 1991).

The redox equilibrium [i.e., Fe3++3OH [symbol] Fe(OH)3 (solid)] is pH dependent and prefers Fe(OH)3 precipitation. There is minimum solubility in the pH levels 7.4-8.5 at which time Fe(OH)2+, Fe(OH)3 and Fe(OH)4− forms predominate. As a result soluble inorganic Fe is more readily available in pH<7.0 soils.

Fe plant uptake results from inorganic Fe availability which relies on the redox and pH status of soils. Soluble Fe-chelating compounds are essential for Fe mobility and transport. Chelating compounds called siderophores are secreted by soil bacteria, fungi and grasses and with high affinity for Fe. Siderophores form complexes with inorganic soluble forms of Fe (e.g., Fe3+) to provide transport mechanisms. Fe3+ and Fe2+ chelates are the primary soluble Fe forms in soil and plant nutrient solutions.

Siderophores are extremely soluble and exist in an extensive range of pH levels which facilitates Fe mobility even in high-pH calcareous soil conditions. Turfgrass phytosiderophores (e.g., muguneic acid, avenic acid, 3-hydroxymugineic acid, distichonic acid) chelate Fe2+ to allow Fe transport in the plant's phloem and symplasm.

The secretion of phytosiderophores by the root tips of grasses occurs when there is a Fe deficiency in order to provide for increased soil Fe mobility and plant acquisition. Phytosiderophoric Fe uptake in grasses is mostly pH independent allowing for Fe acquisition from acidic to calcareous soils.

Often times, ferric iron is a mineral of choice to add to soil for the treatment of iron deficiencies. Ferric iron (Hematite with a chemical formulation of Fe₂O₃) has a red-brown color and has been known to stain concrete.

It would be desirable to have a Magnetite-based iron containing, granulated, soil conditioner treatment in a fashion that not only provides essential iron to soil, but is formulated and designed to help make the iron more available for plant uptake. Furthermore, it would be desirable to have this formulation deliver the optimum amount of iron, and optional nutrients and soil conditioners/amendments, to the soil surrounding plants to provide the greatest iron uptake which results in the greatest greening. Furthermore, it would be desirable to deliver an iron-based product that does not stain concrete.

### SUMMARY OF THE INVENTION

The present invention is directed to the creation of an agglomerated, dry, granular plant iron supplement soil conditioner (wherein “soil conditioner” means a material added to soil, the main function of which is to improve their physical and/or chemical properties and/or their biological activity) system for use as an iron supplement to improve iron deficiencies in plants. The present invention requires the soil conditioner composition be comprised of the Magnetite mineral (chemical formula Fe₃O₄) and a Beneficial Carrier material, wherein the Agglomerates are formed by an Agglomeration Process. The agglomerates become both a carrier (delivery system) for the Magnetite to be delivered to the soil based on desired application rates (wherein “desired application rate” is a predetermined amount that is metered/delivered to the soil to provide a specific and predetermined benefit to the soil), as well as to provide a system of physically helpful and/or chemically interactive additives to help the iron be more readily available for plant utilization.

The present invention provides at least the following solutions to plants deficient in iron: additional iron to aid in plant health, plant growth, soil health, or any combination thereof; and a Beneficial Carrier material Agglomerated with the Magnetite to: serve as a carrier for the Magnetite when Agglomerated with the Magnetite, and also help the iron be more readily available for plant utilization.

It is an object of the present invention to provide an Iron Supplement System wherein the Beneficial Carrier comprises Gypsum.

It is an object of the present invention to provide an Iron Supplement System wherein the Agglomeration Process comprises a Binder.

It is an object of the present invention to provide an Iron Supplement System wherein the binder comprises lignin.

It is an object of the present invention to provide an Iron Supplement System comprising: between about 1%-75% by dry weight of the Magnetite; between about 15%-98% by dry weight of Gypsum.

It is an object of the present invention to provide an Iron Supplement System comprising: between about 25%-50% by dry weight of the Magnetite; between about 50%-75% by dry weight of the Gypsum.

It is an object of the present invention to provide an Iron Supplement System comprising between about 1%-75% by dry weight of the Magnetite; between about 15%-98% by dry weight of the Beneficial Carrier.

It is an object of the present invention to provide an Iron Supplement System further comprising: between about 0.1%-15% by weight of anionic WSPAM; between about 0.01%-10% by weight of Microbes; between about 0.1%-25% by weight of Macronutrient(s); between about 0.1%-20% by dry weight of a Binder; or any combination thereof; wherein the WSPAM and Microbes aid chemically and/or physically in its interaction with the Magnetite, the soil environment, or any combination thereof, to help iron be taken up by plants to treat iron deficiencies in the plants.

It is an object of the present invention to provide an Iron Supplement System wherein the Agglomerates are formed by a single Agglomeration Process.

It is an object of the present invention to provide an Iron Supplement System wherein the Beneficial Carrier comprises limestone derived from calcitic limestone, dolomitic limestone, or any combinations thereof; the Agglomeration Process comprises a Binder.

It is an object of the present invention to provide an Iron Supplement System wherein the Macronutrient(s) comprises water soluble nitrogen; that once dissolved, is immediately available for plants take up; and provides quick greening and growth to the plants.

It is an object of the present invention to provide an Iron Supplement System further comprising a size reduction process; wherein the agglomerates are reduced into smaller particle sizes.

It is an object of the present invention to provide an Iron Supplement System comprising: 2% or greater, between 15-20%, between 20-25%, between 25-30%, between 30-35%, between 35-40%, between 40-45%, or between 45-55% by dry weight of the Magnetite.

It is an object of the present invention to provide a method of improving Iron Deficiency in plants by applying an Iron Supplement System to soil comprising: Processing Magnetite into a Particulate form suitable for Agglomeration with Gypsum; Processing Gypsum into a Particulate form suitable for Agglomeration with the Magnetite Particulate; Agglomerating Magnetite Particulate and Gypsum Particulate into Agglomerates by an Agglomeration Process comprising Tumble Agglomeration, Pressure Agglomeration, or any combination thereof; Drying the Agglomerates to desired moisture content; Screening the Agglomerates to desired particle size; Adding anionic WSPAM, Microbes, Macronutrient(s), Micronutrients, or any combination thereof to the Iron Supplement System by Bulk Blending with the Agglomerates, incorporating into the Agglomeration Process, spray applying, or any combination thereof; Decreasing the Iron Deficiency(ies) in plants by use of the Iron Supplement System on soil with plants deficient in iron; wherein the WSPAM and Microbes aid chemically and/or physically in its interaction with Magnetite, the soil environment, or any combination thereof, to help iron be taken up by plants to treat iron deficiencies in the plants.

It is an object of the present invention to provide a method of improving Iron Deficiency in plants by applying an Iron Supplement System to soil comprising: between about 1%-75% by dry weight of the Magnetite; between about 15%-98% by dry weight of the Gypsum; between about 0.1%-15% by dry weight of anionic WSPAM, between about 0.01%-10% by dry weight of Microbes; between about 0.1%-25% by dry weight of Macronutrient(s), or any combination thereof.

The present invention relates to an Iron Supplement System comprising: Magnetite Particulate; Beneficial Carrier Particulate; Binder; WSPAM; Microbes; and Macronutrient(s).

The present invention relates to an Iron Supplement System comprising: Magnetite Particulate; Beneficial Carrier Particulate comprised of Gypsum; and a Binder; the Beneficial Carrier Particulate comprises at least 50% of the Iron Supplement System.

### BRIEF DESCRIPTION OF FIGURES

FIG. 1 illustrates an exploded view of Magnetite Particles and Gypsum Particles Agglomerated together to form an Agglomerate comprising the Iron Plant System of the present invention.

FIG. 2. Illustrates an exploded view of Magnetite Particles and Gypsum Particles Agglomerated together to form an Agglomerate comprising the Iron Plant System of the present invention, wherein the Agglomerates are then coated with WSPAM and Microbes.

FIG. 3. Illustrates an exploded view of Magnetite Particles and Gypsum Particles Agglomerated together to form an Agglomerate comprising the Iron Plant System of the present invention, wherein the Agglomerates are then coated with WSPAM and Microbes (light gray particles shown) Bulk Blended with a Macronutrient.

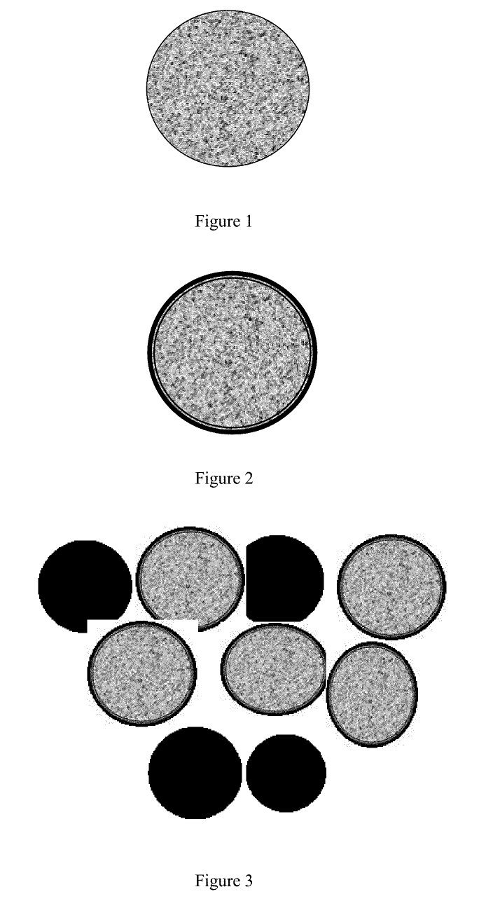

### DETAILED DESCRIPTION OF THE INVENTION

Exemplary embodiments relate to a Plant Iron Supplement System that incorporates at least Magnetite (Fe₃O₄) Particulate and Beneficial Carrier Particulate into an Agglomerated soil amendment product, as well as method of preparation thereof. Exemplary embodiments also relate to methods of using this Iron Supplement System.

Exemplary embodiments provide an Iron Supplement System for treating Iron Deficiencies in plants comprising: Agglomerated Magnetite Particulate and Beneficial Carrier Particulate in the form of Agglomerates; the Beneficial Carrier helps the iron be taken up by the plants to treat the Iron Deficiencies in the plants; the Agglomerates are formed by an Agglomeration Process comprising Agitation Agglomeration, Pressure Agglomeration, Sintering Agglomeration, or any combination thereof; the Iron Supplement System improves effects of the Iron Deficiency in the plants.

It will be readily understood by those persons skilled in the art that the preferred embodiments described herein are capable of broad utility and application. Accordingly, while exemplary embodiments described herein in detail in relation to the exemplary embodiments, it is to be understood that this disclosure is illustrative and exemplary of embodiments, and is made to provide an enabling disclosure of the exemplary embodiments. The disclosure is not intended to be construed to limit the embodiments or otherwise to exclude any other such embodiments, adaptations, variations, modifications and equivalent arrangements.

The figures depict various functionalities and features associated with exemplary embodiments. While a single illustrative feature, or component is shown, these illustrative features, or components may be multiplied for various applications or different application environments. In addition, the features, or components may be further combined into a consolidated unit or divided into sub-units. Further, while a particular structure or type of feature, or component is shown, this structure is meant to be exemplary and non-limiting, as other structure may be able to be substituted to perform the functions described.

It has been found in accordance exemplary embodiments that the Plant Iron Supplement System provides for an easy, productive, and efficient way of correcting the effects of iron deficiency in plants. When applied to soil as intended and directed, plant supplement iron system is able to improve plant life that is adversely affected by iron deficiencies in the plant and/or soil environment without the difficulty, confusion, and inconvenience of applying an iron mineral in combination with other products at a rate and proximity so as to improve plant life suffering from at least iron deficiency.

Exemplary embodiments simplify and remove the general difficulties experienced by novice and seasoned plant/lawn users and growers. These difficulties might include, but are not limited to, the following: the type, amount and particle size of iron to use; the type, amount and particle size of gypsum to use; the closeness in proximity that is required for certain chemical interactions to occur between the plant system components and additives; the type, amount and particle size of nutrient, fertilizer, and soil conditioner additives to use to aid and compliment the greening effect(s) of the added iron component; the type, quantity, charge density, and molecular weight of water-soluble polyacrylamide(s) additives to use to improve both product and plant life performance; the type and quantity of microbe additives to improve both the plant system and general plant life; the application of iron, gypsum, and other additives at controlled rates to the soil by means of conventional dry, granular spreaders; and the general trial and error associated with establishing and maintaining healthy plant life in plants and/or soil deficient in iron. The plant iron supplement system removes the guess work and uncertainty from treating iron deficient plants by use of a single product that is applied to soil and “watered in” similar to other granular products.

### A. Definitions

“Plant iron supplement system”, and “plant system” (hereafter collectively referred to as “Iron Supplement System”) means a pre-engineered, dry, flowable, granule soil conditioner system that agglomerates at least magnetite (Fe₃O₄) particulate and a Beneficial Carrier particulate into agglomerates for the benefit plant life by overcoming the known issues associated with plant iron deficiencies.
“Iron oxide”, “Fe₃O₄”, “magnetite”, “natural magnetite”, “synthetic magnetite”, “black iron oxide”, “iron”, “iron mineral”, “iron nutrient”, “iron fertilizer”, “ferrous-ferric oxide”, “Iron (II) (III) oxide” (herein collectively referred to as “Magnetite”) means iron oxide with a chemical formula of Fe₃O₄ that can be naturally occurring, synthetic, or any combination thereof.
“Iron Uptake” means a plants acceptance and receiving of iron from soil by use of the plants various uptake mechanisms.
“Iron deficiency”, “plant iron deficiency”, “chlorosis”, “known effects associated with plant iron deficiencies” (herein collectively referred to as “Iron Deficiency”) means a lack of iron presence in the plant causing strain on the vital functions of the plant, including, but not limited to, enzyme and chlorophyll production, nitrogen fixing, and development and metabolism. As such, there are identifiable symptoms of iron deficiency in plant life which can include, but are not limited to: decreases in vegetative growth; marked yield and quality losses; leaves of the plant turn yellow, but the veins of the leaves stay green; or any combination thereof.
“Beneficial carrier”, “beneficial carrier material” (herein collectively referred to as “Beneficial Carrier”) means any Particulate material Agglomerated with Magnetite to form the Iron Supplement System Agglomerates, wherein the material aids chemically and/or physically in its interaction with the Magnetite, the soil environment, or any combination thereof to help iron be taken up by plants to treat deficiencies of iron in the plants.
“Gypsum”, “natural gypsum”, “synthetic gypsum” (herein collectively referred to as “Gypsum”) means natural gypsum (CaSO4+2H2O), synthetic gypsum, or any combination thereof.
“Particulate” means of or relating to (minute) separate particles.
“Particle Size” means the controlling dimension of an individual particle as determined by analysis.
“Agglomeration”, “particle size enlargement”, “granulation” (herein collectively referred to as “Agglomeration”) means the action or process of gathering particulate matter to form agglomerates as generally taught and described in Wolfgang Pietsch book entitled, “Size Enlargement by Agglomeration”
“Agglomeration Process” means agglomeration processes consisting of tumble agglomeration (agglomerating, granulating, pelleting); pressure agglomeration (briquetting, tableting, pelletizing); sintering agglomeration, or any combination thereof.
“Agglomerate”, “conglomerate” (herein collectively referred to as “agglomerate”) means an assemblage of particles (a mass) which is either loosely or rigidly joined together with several particles adhering to each other.
“Binder” means an inherent component of or additive to particulate matter providing bonding between the disparate particles.
“Tumble agglomeration”, “agitation agglomeration”, “lift and tumble agglomeration”, “pelleting” (herein collectively referred to as “Agitation Agglomeration”) means to the agglomeration process(s) characterized by the growth of agglomerates, wherein the state of movement of particulate matter or fluids is induced by external forces. External forces may include, but are not limited to, lift and tumble activity, mixing activity, high speed pin activity, rolling activity, or any combination thereof. As such, the wet or ‘green’ agglomerates are formed during suitable movement of the particulate matter containing the binder. The strength of the green agglomerates is mainly caused by interfacial forces and the capillary pressure at freely movable liquid surfaces. Tumble Agglomeration includes, but is not limited to, tumbling, mixing, granulation, pelletizing, balling, conditioning, and instantizing. Common apparatuses include, but are not limited to, mixers (planetary, cone, ribbon, pintype, drum, counter-current, vertical, paddle, pugmills), disc pelletizers (pan granulators), drum pelletizers and cone pelletizers.
“Pressure Agglomeration”, “briquetting”, “tableting”, “pelletizing”, “extruding” (herein referred to as “Pressure Agglomeration”) means the agglomeration process(s) characterized by the formation of agglomerates by the use of very high forces acting on a mass of particulate matter within a defined volume. If fine powders of ‘plastic’ materials, which deform under high pressure, are pressed, no binders are required. The strength of such compacts is caused by van der Waals' forces, valence forces, partial melting and solidification, or interlocking, respectively. Materials with a low melting temperature fuse at the grain boundaries to form homogeneous structures; similar results can be obtained with almost all materials during hot pressing. Natural components of the materials may be activated by the prevailing high forces to become binders. Only a few ‘difficult’ materials require the addition of dry or liquid binders and/or lubricants. Pressure Agglomeration includes, but is not limited to, briquetting, compacting, extrusion, pelleting, molding, tabletting and isostatic pressing. Common apparatuses include, but are not limited to, roller presses (roll briquetters, roll compactors), piston/ram presses, pellet mills (ring die, flat die), extruders (auger, screw, screen, basket), tablet presses.
“Sintering Agglomeration” means the agglomeration process(s) characterized by the formation of agglomerates, wherein a particle bed is heated until, by atomic and molecular diffusion, sinter bridges develop at the points of contact between the particles. After cooling, the sinter is crushed into the required particle size.
“Bulk Blended”, “mix”, “blend”, “mixture” (herein referred to as “Bulk Blend”) means mixing two or more components together, wherein the mixed components are individually distinct and capable of being separated (ex. a can of mixed nuts).
“Macronutrient(s)” means nitrogen (N), phosphorus (P), and/or potassium (K). “Micronutrients” means essential plant nutrient elements defined as Micronutrients [boron (B), zinc (Zn), manganese (Mn), iron (Fe), copper (Cu), molybdenum (Mo), chlorine (Cl)].
“Water-soluble polyacrylamides”, “water-soluble polymers”, “co-polymers”, “linear polymers” (herein referred to as “WSPAM”) means water-soluble polymers known in the art for use in ionically bonding soil particles together.
“Microbes”, “soil Microbes” (herein referred to as “Microbes”) means the species of microorganisms known in the art to, once applied to soil, can: boost soil value; optimize plant growth; increase crop performance; improve the efficiency of fertilizer, soil amendments/conditioners and/or water in the growing process; or any combination thereof.

### B. Iron

As previous defined above, Magnetite means iron oxide with a chemical formula of Fe₃O₄ that can be naturally occurring or synthetic.

There are different iron oxides known in the industry. The present invention is rooted in the essential use of Magnetite. There are differences between the Magnetite, and that which is derived from hematite iron oxide (Fe₂O₃) known in industry (herein referred to as “Hematite”). The difference between Magnetite and Hematite can be discussed in terms of their chemical as well as physical properties and usage. Both of these minerals are naturally occurring iron oxides. But, most of their properties and usages are different from each other. They both are colorful oxides with different colors, which are used as pigments and possess ferromagnetic properties.

A Magnetite of the present invention contains both Fe2+ and Fe3+ ions. Therefore, it is sometimes referred to in industry as Iron (II) (III) oxide. The IUPAC name of Magnetite is iron (II) iron (III) oxide. It is also known as ferrous-ferric oxide. It can be formed by FeO and Fe₂O₃, the natural form of this mineral is magnetite. It possesses strong magnetic properties. It naturally occurs in almost all igneous and metamorphic rocks as small grains. It is black or brownish-black in color with a metallic luster. The powdered form of Magnetite is also known to be a good sorbent. The crystal structure of Magnetite is “cubic inverse spinel structure.” Magnetite contains both (+II) and (+III) oxidation states. The electrical conductivity of Magnetite is significantly higher (* 106) than Hematite. The reason for this property is due to the ability to exchange electrons between Fe2+ and Fe3+ centers in Magnetite.

In contrast, Hematite (Fe₂O₃) has a red-brownish color with a metallic luster. The mineral form of Hematite is also called haematite. The IUPAC name of this compound is iron (III) oxide, also known as ferric oxide. It is an inorganic compound that has several phases of crystal structures. It is dark red in color. It appears as a red-brown solid. Hematite is the main source of iron in steel and iron industry, and it is used to produce some alloys. Hematite has several crystal forms as alpha phase, gamma phase, and other phases. Alpha-Hematite has the rhombohedral structure, gamma-Hematite has the cubic structure, and beta phase has cubic body-centered structure. In Hematite, the oxidation state of iron is (+III).

As defined above, Magnetite can be natural or synthetic. Pigment quality Magnetite, so called synthetic magnetite, can, but don't necessarily have to, be prepared using processes that utilize industrial wastes, scrap iron or solutions containing iron salts.

How does iron oxide become available for plant uptake and how do plants then uptake the available iron from Fe₃O₄ (Magnetite)? Any nutrients that plants uptake from the soil environment must be in a soluble or dissolved form in order for plants to absorb them. Fe₃O₄ is an iron oxide that contains Fe(II) and Fe(III); two different oxidation states of iron. The majority of the iron found in soils is in an insoluble form. Plants have different strategies available to them to access iron in the soil environment. If iron is not soluble and available, plants can release protons into the soil solution to increase iron solubility. This increase in protons helps lower soil pH, which makes iron more soluble. Every one unit drop in pH makes iron 1000 times more soluble, so small changes in pH can promote iron availability. Plants then release chelating agents called siderophores (low molecular weight compounds with high iron affinity) that form complexes with the ions to prepare them for transport into the plant through roots.

Why do soils need iron? The positive charge of iron ions can attract negatively charged clay particles which, in some cases, can provide great aggregate stability which benefits the soil structure. Good soil structure is needed for root growth, air and water movement, and reduces soil erosion.

How does iron from Fe₃O₄ then help plants? The Fe₃O₄ can be utilized by plants just as naturally occurring iron in the soil can be used. When plants need iron they will release ions and siderophores to make the iron available. The addition of some Iron Supplement System formulations start providing benefits from iron within a few of days after its addition to the soil environment and significant improvements are seen in a few weeks.

One of skill would know what quality, quantity and form of Magnetite to include in the Iron Supplement System in order to achieve the desired benefit offered by inclusion of the Magnetite.

### C. Beneficial Carrier

A Beneficial Carrier of the present invention provides value to the Iron Supplement System in at least the following ways:
1. It serves as a bulking agent when agglomerated with the Magnetite particulate to form the Plant Iron System Agglomerates. The resulting Iron Supplement System Agglomerates: provide a value-added distribution system for the Magnetite that has a lower bulk density than Agglomerates of pure Magnetite; and creates agglomerates that are of industry standard in size while allowing for improved particle distribution of the Magnetite as it is included over a greater number of granules per square foot than a pure Magnetite containing Agglomerate of similar size.
2. It aids chemically and/or physically in its interaction with both the Magnetite and soil environment to help iron be taken up by plants to treat deficiencies of iron in the plants.

Gypsum was found to be a Beneficial Carrier. Calcitic and dolomitic limestone were found to be Beneficial Carriers.

### D. Gypsum

Gypsum provides tremendous value as a Beneficial Carrier for at least two reasons. First and foremost, its intimate combination with the iron in a homogenous granule aids both chemically and physically in its interaction with both the iron and the soil environment to help iron be better taken up by plants to treat deficiencies of iron. Secondly, it serves as a value-added distribution system (carrier) of the iron when they are agglomerated together by creating a lighter product with improved particle distribution, resulting in uniform application of the product.

Gypsum, also known as Calcium Sulfate (CaSO₄), is a widely available lawn and garden amendment. The Calcium and Sulfur found in gypsum are both plant macronutrients. Calcium is essential for cell elongation, cell division, membrane permeability, and is an activator of critical enzymes. Sulfur, derived from Sulfate, is used in the formation of amino acids, proteins, chlorophyll formation, and enzymes. Sulfur needs to be in the sulfate form to be taken up by the roots.

Natural gypsum is a naturally occurring mineral that is made up of calcium sulfate and water (CaSO4+2H2O) that is sometimes called hydrous calcium sulfate. It is the mineral calcium sulfate with two water molecules attached. Gypsum can have a solubility that is 150 times that of limestone, hence it is a natural source of plant nutrients. Synthetic gypsum forms include, but are not limited to, FGD (Flue Gas Desulfogypsum) or DSG or (DeSulfoGypsum) from the scrubbing of SO2 gases from coal-fired power plants, Titanogypsum from the production of TiO2 pigments, Phosphogypsum from the production of phosphate fertilizers and Fluorogypsum from the production of hydrofluoric acid.

There are many benefits known in the art for applying gypsum to soil which include, but are not limited to, improve the physical condition of the soil; a source of anions (negatively charged) and cations (positively charged) to promote the flocculation and inhibit dispersion of soil aggregates as flocculation or particle aggregation are essential for good soil structure, which allows for root growth, air and water movement, and reduces soil erosion; reduces aluminum levels, which is toxic to plants; and is a neutral salt, offering ions to the solution but not changing soil pH.

Gypsum is readily dissolvable in the soil solution and the calcium and sulfate contained in Gypsum are immediately ready for plant uptake. With help of soil microorganisms, Gypsum's calcium and sulfur components are released into the soil's micro-environment containing the Magnetite particulate, creating a new micro-environment around the Magnetite in the soil rich in calcium and sulfur—helpful for plants ability to uptake. Furthermore, the stability of the aggregates formed by use of the Gypsum, along with the preservation of the pore space, allows for deeper penetration of roots to access subsoil moisture—creating a better environment for plants to uptake nutrients and moisture.

One of skill would know what quality, quantity and form of gypsum to include in the Iron Supplement System in order to improve the ability of iron uptake by the plants and achieve other desired benefit offered by inclusion of gypsum.

### E. WSPAM

Adding WSPAM to the Iron Supplement System product helps to provide a myriad of benefits both to the soil and plant life. WSPAM holds nutrients (including iron, calcium and sulfur) in the soil for longer so the nutrients are available to plants for an extended period of time. WSPAM binds soil particles together, improving soil structure, which allows for better root growth, allowing the roots to more easily reach the needed nutrients, including iron. In addition, WSPAM reduces soil erosion, which keeps the nutrients in place near the plant roots.

WSPAM has the ability to dissolve, chelate and sequester nutrients, including iron. This allows iron to stay in a plant available form so it will be accessible when the plant requires it. WSPAM creates a micro-environment around the Magnetite in the soil (like organic matter in the soil) that micro-organisms like to grow in to make the iron from the Magnetite (and iron in the soil) more available and the natural chelation makes it easier for plants to absorb the sulfur and iron. Furthermore, with the help of the calcium in the gypsum, WSPAM helps to bind to the soil, iron, and sulfur—preventing runoff and leaching—helping to maintain the nutrients in the rhizosphere and to make these available for plant use.

WSPAM is known in the industry to be an effective soil conditioning material when properly applied to soil. It works by ionically bonding soil particles together. Anionic WSPAM has been sold since 1995 to reduce irrigation-induced erosion and enhance infiltration. Its soil stabilizing and flocculating properties improve runoff water quality by reducing sediments, N, dissolved reactive phosphorus (DRP) and total P, chemical oxygen demand (COD), pesticides, weed seeds, and microorganisms in runoff. WSPAM used for erosion control is a large (12-15 Mg mol-1) water-soluble (noncross-linked) anionic molecule, containing <0.05% acrylamide monomer.

There are many known benefits of WSPAM, including, but not limited to, soil benefits, plant health benefits, nutrient benefits, and environmental benefits. The soil benefits can include: reduced soil erosion by ionically bonding and holding soil particles in place; increased soil permeability by stabilizing surface pore structure and pore continuity; prevention of the formation of soil crust by stabilizing soil particles and soil pores; increased water infiltration and water retention; reduced soil compaction by reducing particle dispersion; reduced soil rilling by creating soil aggregates and holding them in place; and stabilized soil preventing detach. The plant nutrient benefits can include: increased air exchange in the soil by preventing soil crusting and reducing compaction; increased seed germination rate and enhanced seedling emergence; helps maintain seed placement by stabilizing the soil environment around the seed; holds pesticides and herbicides in place-reducing the amount needed; improved crop yield and expedited crop maturity; increased viability of shrub, tree, and vegetable transplants; increased root biomass in plants; promoted plant growth; and deepened plant rooting. Nutrient benefits can include: increased available soil nutrients through decreased nutrient leaching; nutrient availability to plants for longer; reduced nutrient runoff thereby reducing fertilizer application rates; ability to chelate and sequester nutrients; provision of a nitrogen source to soil bacteria; and holding on to fertilizers in the soil thusly reducing fertilizer costs. Environmental benefits can include: reduced nutrient runoff into surrounding waterways by holding soil and fertilizers in place; improved water quality by preventing erosion and sediment in suspension; reduced soil loss during and after construction by holding soil in place; prevention of pathogens from animal waste from leaching into water; and reduced surface and groundwater contamination by holding fertilizers in the soil.

As taught in Encap's U.S. Pat. Nos. 7,503,143, 7,730,662, 7,874,101; and 8,316,580, a solid carrier can be used to apply WSPAM to the soil. In the present invention, WSPAM can be added directly to the agglomerates.

One of skill in the art would know the amount and formulation of WSPAM to include in the Iron Supplement System, based on the desired amount of WSPAM to be released (leached) to the soil once the agglomerates, serving as the solid carrier for the WSPAM, are metered to the soil to perform the desired end-function within the soil.

### F. Microbes

Adding Microbes to the Plant Iron Supplement System improves root growth and increases plant uptake and utilization of nutrients, from both applied fertilizer and in the soil. The Microbes help to provide an environmental balance between soil and plant by “linking” cycles and processes that occur in the soil and plant together. Plants have a symbiotic relationship with Microbes. Plant roots release exudates that are then transformed by PGPR (Plant Growth Promoting Rhizobacteria) into useful metabolites (as stated previously), necessary for converting nutrients into plant useable forms. The combination of Microbes are designed to build a healthy soil rhizosphere which can support increased plant growth and productivity. The rhizosphere is the narrow region of soil that is directly influenced by root secretions and associated soil microorganisms. The Microbes start by increasing the availability of Phosphorus through an enzymatic process and chelate Fe through the synthesis of siderophores. Microbes also improve water utilization and N utilization, via greater capture due to improved root architecture and increase of root absorptive area. This also helps mitigate nutrient leaching and runoff Rooting is enhanced by the production of plant hormones, IAA(Indole-3-acetic acid) for example, that stimulate root hair and root tip growth. The end result is a more productive soil that improves the effectiveness of fertilizer applications and provides a more vigorous and healthy plant.

The Microbes produce siderophores, which chelate and competitively acquire ferric iron. Siderophores form soluble iron complexes reducing Fe³ to Fe² which stay in solution, increasing the concentration of total soluble iron. The Microbes also promote root growth through the production of growth hormones. By increasing the root absorptive area in the soil (more roots), the plant can better utilize nutrients applied via fertilizers, including iron that has been chelated via siderophores. Once the bacterial endospores “germinate”, they begin normal multiplication and colonization of the rhizosphere. Germination happens as soon as the soil environment is conducive, or once the fertilizer has been watered in, (rain or irrigation) and the spores have reached the root zone. This gives rise to increased root and shoot growth, lateral root and root hair development, increased leaf surface area and chlorophyll content, improved tolerance to stress, and increased plant productivity.

Microbes coated on the Iron Supplement System product can be PGPR from within the Bacillus genus. This blend of PGPR have the natural ability to increase plant growth and plant health. The Microbes transform sugars and other nutrients into useful metabolites, (i.e. enzymes, hormones, lipopeptides, biosurfactants, etc.) in the rhizosphere. These metabolites immediately go to work in the soil to enhance nutrient uptake, root growth, and systemic plant defense. The initial deployment of the PGPR is a bacterial endospore. The endospore is a survival mechanism employed by bacteria. The endospore can be considered a defensive structure enabling the bacteria to survive under adverse conditions. When the sporulated bacteria are placed in a soil environment, they come out of their “protective shell” and rapidly expand in number and begin producing metabolites.

One of skill would know what quality, quantity and form of Microbes to include in the Iron Supplement System in order to improve the ability of iron uptake by the plants and achieve other desired benefit offered by inclusion of the Microbes.

### G. Fertilizers

Nitrogen is absorbed by plants in the form of nitrate and NH₄⁺ ions. The mix of slow release and uncoated urea when formulated with the Iron Plant System product improves the chances of plants acquiring nitrogen when they need it and before it is cycled away by other biology in the soil environment. Spacing out the timing of nitrogen availability improves the support of plant development. This development of biomass, particularly in the root systems supports the plant's ability to acquire other nutrients, including iron. The addition of nitrogen increases the plant's ability to uptake iron while also producing a fast acting “greening” effect for plant life provided by the soluble nitrogen.

Nitrogen is a macronutrient typically making up 1 to 6% of a plant tissue. Plants need nitrogen because it is a constituent of many plant substances including: amino acids that make up proteins, nucleic acids that include DNA and RNA, chlorophyll, and enzymes that control biological activities. Proper management of nitrogen is important because nitrogen can often be a limiting nutrient to plants and it is easily lost from the soil environment through leaching and ammonization. Nitrogen stimulates carbohydrate use within plants and nutrient uptake by stimulating root growth. Nitrogen deficiencies can slow and stunt plant growth.

Nitrogen is needed by the biotic members of the soil environment. All soil organisms need nitrogen for amino acids to make proteins, nucleic acids for DNA and RNA, and enzymes for internal biological activities. These needs and the relative inaccessibility to atmospheric nitrogen (to most organisms) have formed a tight cycling of nitrogen within organic compounds of the soil environment.

Fertilizers are known to include Macronutrients and Micronutrients. Nitrogen is a Macronutrient. Nitrogen is one of the most important nutrients for crop growth, second only to water, and is the major nutrient the producer can control. Nitrogen exists in many different chemical forms and passes around natural and agricultural ecosystems in a cycle.

Nitrogen is one of the main chemical elements required for plant growth and reproduction. Nitrogen is a component of chlorophyll and therefore essential for photosynthesis. It is also the basic element of plant and animal proteins, including the genetic material DNA and RNA, and is important in periods of rapid plant growth. Plants use nitrogen by absorbing either nitrate or ammonium ions through the roots. Most of the nitrogen is used by the plant to produce protein (in the form of enzymes) and nucleic acids. Nitrogen is readily transported through the plant from older tissue to younger tissues. Therefore, a plant deficient in nitrogen will show yellowing in the older leaves first due to the underdevelopment or destruction of chloroplasts and an absence of the green pigmented chlorophyll.

The sources of nitrogen found in fertilizers can be broken up in to slow release sources (water insoluble nitrogen) or quick release sources (water soluble nitrogen). In the latter, the fertilizer is readily soluble in water and, once dissolved, the nitrogen is immediately available for grass plants to take up and use. Common examples of quick release sources include ammonium sulfate, ammoniacal nitrogen and urea. As a result, grass plants green up very quickly and grow vigorously for a relatively short period of time following an application of quick release nitrogen.

One of skill would know what quality, quantity and form of Macronutrients and Micronutrients to include in the Iron Supplement System in order to improve the ability of iron uptake by the plants and achieve other desired benefit offered by inclusion of the Macronutrients and Micronutrients.

### EXAMPLES

### Example 1

An Iron Supplement System product was produced with the following components:
1. Magnetite and Gypsum were processed into a suitable particulate form in preparation for Agglomeration.
2. The Magnetite Particles and Gypsum Particles were mixed together and Agglomerated into Agglomerates utilizing an Agitation Agglomeration process, along with a lignosulfonate binder.
3. The Agglomerates are then dried to the desired moisture content.
4. The Agglomerates are then screened to desired particle size.

### Example 2

An Iron Supplement System product was produced with the following components:
1. Magnetite and Gypsum were respectively processed into Particulate form by both size reduction and particle screening.
The Gypsum particle size consisted of 73% passing through 200 mesh, and 85% passing through 100 mesh. The Gypsum was sourced through Calcium Products and contained calcium (Ca) at approximately 21.3%, and sulfur (S) at approximately 16.3%.
The Magnetite contained Fe at approximately 68-70.5%. The moisture content was below 1%. The Magnetite particle size consisted of 100% passing through 20 mesh; 96% passing through 200 mesh; and 90% passing through 300 mesh.
2. These two particulate materials are then processed through a high speed pin mixer to help ensure uniform Bulk Blending of the two materials prior to the Agitation Agglomeration process.
3. The Bulk Blended materials are then fed onto a conventional rotating pan pelletizer and Agglomerated into Agglomerates with the addition of lignosulfonate as a binder.
4. The Agglomerates are then dried to desired moisture content.
5. The Agglomerates are then screened to desired particle size, as required.
6. The screened Agglomerates are fed into a coating drum where WSPAM and Microbes are spray applied onto the agglomerates while fertilizer is concurrently Bulk Blended with the Agglomerates to make the Iron Supplement System soil conditioner product.

### Example 3

The Iron Supplement System soil conditioner product of Example 2 was used to treat iron deficient grass plants in a controlled grow-out study.

Materials and Methods: Plastic pots (6″ diameter×7″ deep) were filled in a greenhouse with Premier Horticulture (Quakertown, Pa.) “Promix HP” no-nutrient planting media. All pots were seeded with Titan RX turf-type tall fescue turfgrass lot number B3-13-5107 from crop production year 2013. Greenhouse temperatures were calibrated to optimum cool-season turfgrass growing conditions of 60° F. dark/75° light with 14 h day lengths. Nutrients (i.e., N, P, K, S, Ca, Mg, Mn, Zn, and Cl) for healthy plant development (with the exception of Fe) were then applied to all experimental units. Then, the Iron Supplement System soil conditioner product of Example 2 was compared to other competitive products.

Results: The Iron Supplement System soil conditioner product of Example 2 provided superior plant leaf tissue iron (ppm) when compared to the competitive products and the control treatments. It was found that the Iron Plant System of Example 2 provided excellent plant health providing optimum leaf tissue iron (ppm) content in relation to the competitive products and the control treatments.

Discussion: The inclusion of WSPAM in Iron Supplement System soil conditioner product of Example 2 retained plant-available Fe within the rhizosphere allowing for more efficient plant uptake. Further, the Gypsum improved the physical condition of the soil by promoting flocculation and inhibiting aggregate dispersion, permitting greater infiltration of water, and reducing strength of hard subsurface layers allowing for deeper penetration of roots to access subsoil moisture. The addition of nutrients provided for balanced plant nutrition. Microbes increased metabolic diversity within the rhizosphere allowing plants to more effectively access the Fe, carbon and energy required to generate the photosynthates and cellular constituents required for good plant health and development.

### Example 4

An experiment was designed to test the staining impact of iron products on concrete. Two grams of a leading competitive iron product and two grams of Iron Supplement System soil conditioner product of Example 2 were placed on a concrete block. Five milliliters of water was poured onto each treatment and left for one hour. The concrete block was then washed and dried. The leading competitive iron product left behind very visible, permanent staining, while the Iron Supplement System soil amendment product of Example 2 did not stain the concrete.

It should be understood, of course, that the foregoing relates to exemplary embodiments of the invention and that modifications may be made without departing from the spirit and scope of the invention.

1. An Iron Supplement System for treating Iron Deficiencies in plants comprising:
Agglomerated Magnetite Particulate and Beneficial Carrier Particulate in the form of Agglomerates;
said Beneficial Carrier Particulate helps said iron be taken up by said plants to treat said Iron Deficiencies in said plants;
said Agglomerates formed by an Agglomeration Process comprising Agitation Agglomeration, Pressure Agglomeration, Sintering Agglomeration, or any combination thereof;
said Iron Supplement System improves effects of said Iron Deficiency in said plants.

2. The Iron Supplement System of claim 1 wherein said Beneficial Carrier Particulate comprises Gypsum.

3. The Iron Supplement System of claim 2 wherein said Agglomeration Process comprises a Binder.

4. The Iron Supplement System of claim 3 wherein said Binder comprises lignin.

5. The Iron Supplement System of claim 2 wherein said Iron Supplement System comprises:
between about 1%-75% by dry weight of said Magnetite Particulate; and
between about 15%-98% by dry weight of said Gypsum.

6. The Iron Supplement System of claim 2 wherein said Iron Supplement System comprises:
between about 25%-50% by dry weight of said Magnetite Particulate; and
between about 50%-75% by dry weight of said Gypsum.

7. The Iron Supplement System of claim 1 wherein said Iron Supplement System comprises:
between about 1%-75% by dry weight of said Magnetite Particulate; and
between about 15%-98% by dry weight of said Beneficial Carrier Particulate.

8. The Iron Supplement System of claim 5 wherein said Iron Supplement System further comprises:
between about 0.1%-15% by weight of anionic WSPAM;
between about 0.01%-10% by weight of Microbes;
between about 0.1%-25% by weight of Macronutrient(s);
between about 0.1%-20% by dry weight of a Binder; or any combination thereof;
wherein said WSPAM and said Microbes aid chemically and/or physically in its interaction with said Magnetite Particulate, soil environment, or any combination thereof, to help said iron be taken up by said plants to treat said iron deficiencies in said plants.

9. The Iron Supplement System of claim 1 wherein said Agglomerates are formed by a single Agglomeration Process.

10. The Iron Supplement System of claim 1 wherein said Beneficial Carrier Particulate comprises limestone derived from calcitic limestone, dolomitic limestone, or any combinations thereof; said Agglomeration Process comprises a Binder.

11. The Iron Supplement System of claim 8 wherein said Macronutrient(s) comprises water soluble nitrogen; that once dissolved, is immediately available for plants uptake; providing quick greening and growth to said plants.

12. The Iron Supplement System of claim 1 further comprising a size reduction process; wherein said agglomerates are reduced into smaller particle sizes.

13. A method of improving Iron Deficiency in plants by applying an Iron Supplement System to soil comprising:
processing magnetite into a particulate form suitable for agglomeration with gypsum;
processing said gypsum into a particulate form suitable for agglomeration with said magnetite particulate;
agglomerating said magnetite particulate and said gypsum particulate into agglomerates by an agglomeration process comprising tumble agglomeration, pressure agglomeration, or any combination thereof;
drying said agglomerates to desired moisture content;
screening said agglomerates to desired particle size;
adding anionic WSPAM, Microbes, Macronutrient(s), Micronutrients, or any combination thereof to said Iron Supplement System by bulk blending with said agglomerates, incorporating into said agglomeration process, spray applying, or any combination thereof;
wherein said WSPAM and said Microbes aid chemically and/or physically in its interaction with said Magnetite particulate, soil environment, or any combination thereof, to help iron be taken up by said plants to treat deficiencies of said iron in said plants;
decreasing said Iron Deficiency(ies) in said plants by use of said Iron Supplement System on soil with said plants deficient in said iron.

14. The method of claim 13 wherein said Iron Supplement System comprises: between about 1%-75% by dry weight of said Magnetite; between about 15%-98% by dry weight of said Gypsum; between about 0.1%-15% by dry weight of anionic WSPAM, between about 0.01%-10% by dry weight of Microbes; between about 0.1%-25% by dry weight of Macronutrient(s), or any combination thereof.

15. An Iron Supplement System comprising:
Magnetite Particulate;
Beneficial Carrier Particulate;
Binder;
WSPAM;
Microbes; and
Macronutrient(s).

16. An Iron Supplement System comprising:
Magnetite Particulate;
Beneficial Carrier Particulate comprised of gypsum;
and a Binder;
said Beneficial Carrier Particulate comprises at least 50% of said Iron Supplement System.
